(19) United States
(12) Patent Application Publication
(10) Pub. No.: US 2024/0251401 A1
(43) Pub. Date: Jul. 25, 2024

(54) RESOURCE ALLOCATION FOR MULTIPLE COMPONENT CARRIER TRANSMISSIONS

(71) Applicant: Intel Corporation, Santa Clara, CA (US)

(72) Inventors: Gang Xiong, Beaverton, OR (US); Yingyang Li, Beijing (CN); Yi Wang, Beijing (CN)

(21) Appl. No.: 18/290,366

(22) PCT Filed: Jan. 16, 2023
(86) PCT No.: PCT/US2023/010862

§ 371 Date: Nov. 13, 2023

Related U.S. Application Data
(60) Provisional application No. 63/300,555, filed on Jan. 18, 2022.
(60) Provisional application No. 63/328,096, filed on Apr. 6, 2022.

(51) Int. Cl. H04W 72/1268; H04W 72/0453; H04W 72/0457; H04W 72/1273; H04W 72/231

(52) U.S. Cl. CPC H04W 72/1268; H04W 72/0453; H04W 72/0457; H04W 72/1273; H04W 72/231

(57) ABSTRACT

An apparatus and system of providing resource allocation for PDSCH and/or PUSCH transmissions with multi-cell scheduling are described. For multi-cell scheduling, one or more of a carrier indicator, bandwidth part (BWP) indication, UL/SUL indicator, frequency domain resource allocation (FDRA) and/or time domain resource allocation (TDRA) may be provided by a NG-RAN node to a UE. In some cases, a carrier indication bitmap may be provided in downlink channel information to indicate single or multi-cell scheduling, as well as the scheduled cells.

### PRIORITY CLAIM

This application claims the benefit of priority to U.S. Provisional Patent Application Ser. No. 63/300,555, filed Jan. 18, 2022, and Provisional Patent Application Ser. No. 63/328,096, filed Apr. 6, 2022, each of which is incorporated herein by reference in its entirety.

### TECHNICAL FIELD

Embodiments pertain to 3GPP networks. In particular, some embodiments relate to mechanisms to resource allocation for data and control transmissions with multi-cell scheduling in 3GPP networks.

### BACKGROUND

The use and complexity of wireless systems has increased due to both an increase in the types of electronic devices using network resources as well as the amount of data and bandwidth being used by various applications, such as video streaming, operating on the electronic devices. As expected, a number of issues abound with the advent of any new technology, including complexities related to scheduling in networks—and in particular extending both uplink and downlink scheduling from a single cell to multiple cells.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1A illustrates an architecture of a network, in accordance with some aspects.

FIG. 1B illustrates a non-roaming 5G system architecture in accordance with some aspects.

FIG. 1C illustrates a non-roaming 5G system architecture in accordance with some aspects.

FIG. 2 illustrates a block diagram of a communication device in accordance with some embodiments.

FIG. 3 illustrates multi-cell scheduling for a physical downlink shared channel (PDSCH) in accordance with some embodiments.

FIG. 4 illustrates a Time Domain Resource Allocation (TDRA) indication for multi-cell scheduling in accordance with some embodiments.

FIG. 5 illustrates a TDRA indication for multi-cell scheduling in accordance with some embodiments.

FIG. 6 illustrates a flowchart of downlink control information (DCI) reception in accordance with some embodiments.

FIG. 7 illustrates a flowchart of DCI reception in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

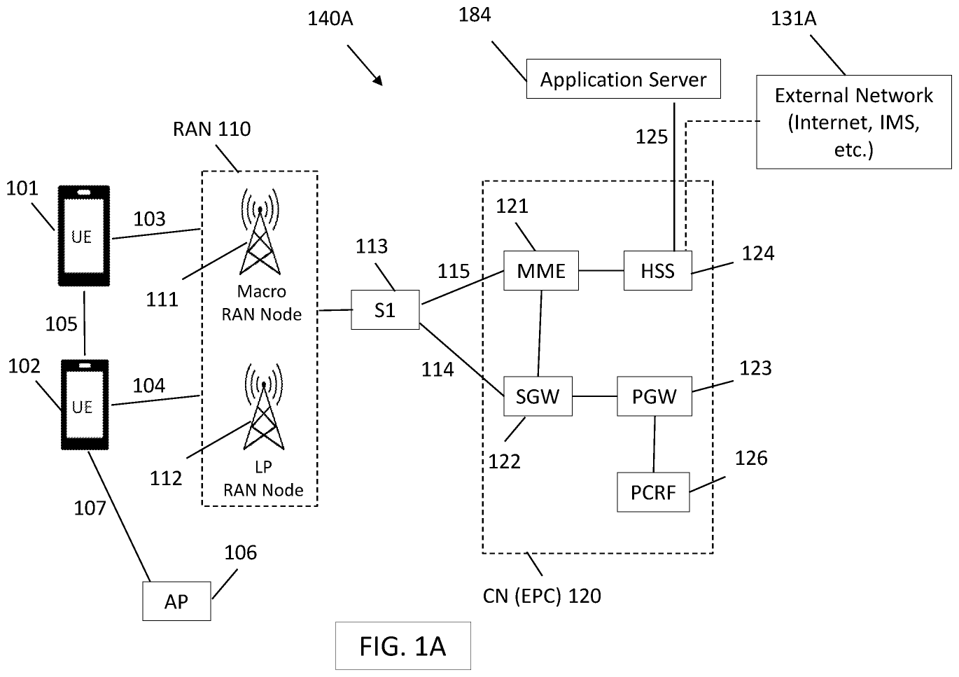

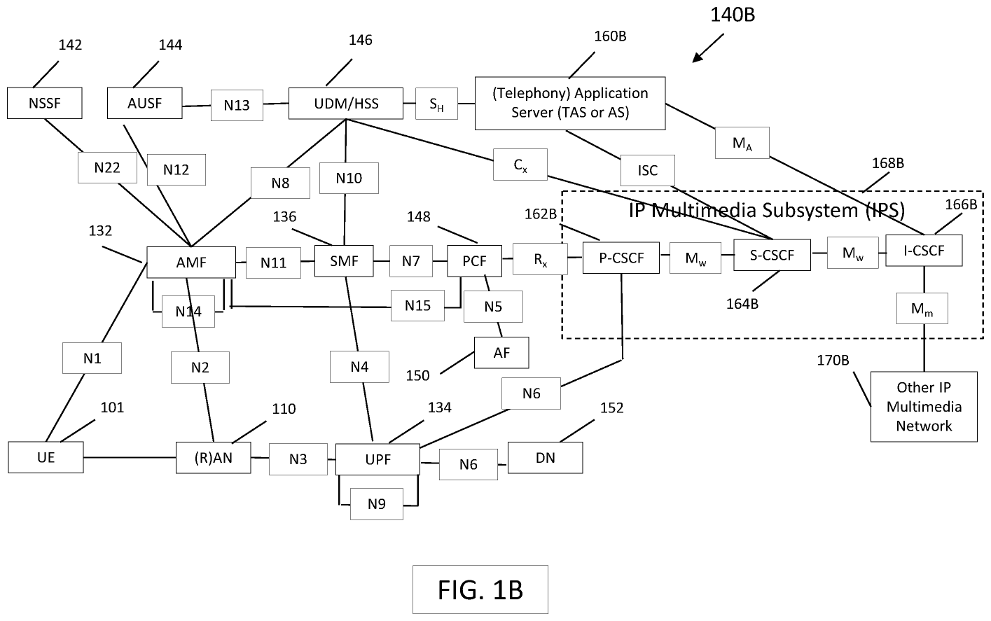

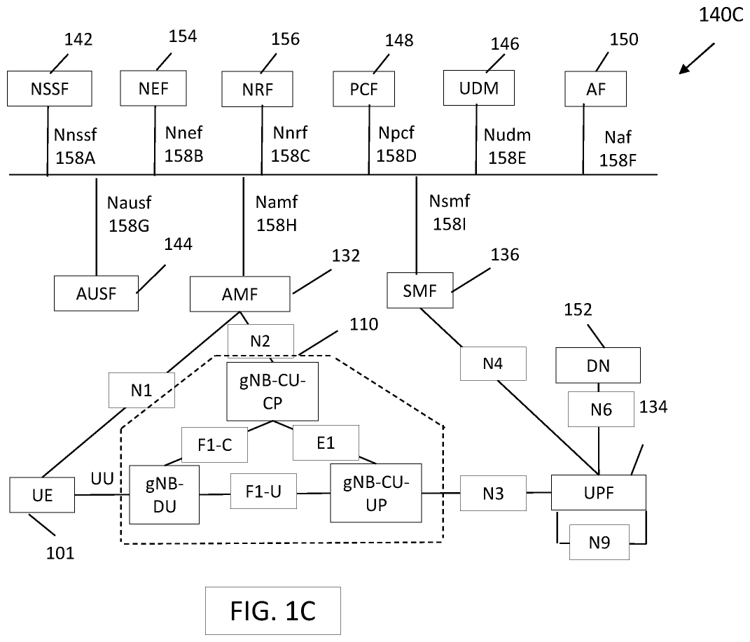

FIG. 1A illustrates an architecture of a network in accordance with some aspects. The network 140A includes 3GPP LTE/4G and NG network functions that may be extended to 6G and later generation functions. Accordingly, although 5G will be referred to, it is to be understood that this is to extend as able to 6G (and later) structures, systems, and functions. A network function can be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 can be collectively referred to herein as UE 101, and UE 101 can be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum, (licensed) shared spectrum (such as Licensed Shared Access (LSA) in 2.3-2.4 GHz, 3.4-3.6 GHZ, 3.6-3.8 GHz, and other frequencies and Spectrum Access System (SAS) in 3.55-3.7 GHz and other frequencies). Different Single Carrier or Orthogonal Frequency Domain Multiplexing (OFDM) modes (CP-OFDM, SC-FDMA, SC-OFDM, filter bank-based multicarrier (FBMC), OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN. The RAN 110 may contain one or more gNBs, one or more of which may be implemented by multiple units. Note that although gNBs may be referred to herein, the same aspects may apply to other generation NodeBs, such as 6th generation NodeBs—and thus may be alternately referred to as next generation NodeB (xNB).

Each of the gNBs may implement protocol entities in the 3GPP protocol stack, in which the layers are considered to be ordered, from lowest to highest, in the order Physical (PHY), Medium Access Control (MAC), Radio Link Control (RLC), Packet Data Convergence Control (PDCP), and Radio Resource Control (RRC)/Service Data Adaptation Protocol (SDAP) (for the control plane/user plane). The protocol layers in each gNB may be distributed in different units—a Central Unit (CU), at least one Distributed Unit (DU), and a Remote Radio Head (RRH). The CU may provide functionalities such as the control the transfer of user data, and effect mobility control, radio access network sharing, positioning, and session management, except those functions allocated exclusively to the DU.

The higher protocol layers (PDCP and RRC for the control plane/PDCP and SDAP for the user plane) may be implemented in the CU, and the RLC and MAC layers may be implemented in the DU. The PHY layer may be split, with the higher PHY layer also implemented in the DU, while the lower PHY layer is implemented in the RRH. The CU, DU and RRH may be implemented by different manufacturers, but may nevertheless be connected by the appropriate interfaces therebetween. The CU may be connected with multiple DUs.

The interfaces within the gNB include the E1 and front-haul (F) F1 interface. The E1 interface may be between a CU control plane (gNB-CU-CP) and the CU user plane (gNB-CU-UP) and thus may support the exchange of signaling information between the control plane and the user plane through E1AP service. The E1 interface may separate Radio Network Layer and Transport Network Layer and enable exchange of UE associated information and non-UE associated information. The E1AP services may be non UE-associated services that are related to the entire E1 interface instance between the gNB-CU-CP and gNB-CU-UP using a non UE-associated signaling connection and UE-associated services that are related to a single UE and are associated with a UE-associated signaling connection that is maintained for the UE.

The F1 interface may be disposed between the CU and the DU. The CU may control the operation of the DU over the F1 interface. As the signaling in the gNB is split into control plane and user plane signaling, the F1 interface may be split into the F1-C interface for control plane signaling between the gNB-DU and the gNB-CU-CP, and the F1-U interface for user plane signaling between the gNB-DU and the gNB-CU-UP, which support control plane and user plane separation. The F1 interface may separate the Radio Network and Transport Network Layers and enable exchange of UE associated information and non-UE associated information. In addition, an F2 interface may be between the lower and upper parts of the NR PHY layer. The F2 interface may also be separated into F2-C and F2-U interfaces based on control plane and user plane functionalities.

The UEs 101 and 102 utilize connections 103 and 104, respectively, each of which comprises a physical communications interface or layer (discussed in further detail below); in this example, the connections 103 and 104 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a 5G protocol, a 6G protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) can be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 can be transmission-reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and can be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 can be a gNB, an eNB, or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VOIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A can be an IoT network or a 5G or 6G network, including 5G new radio network using communications in the licensed (5G NR) and the unlicensed (5G NR-U) spectrum. One of the current enablers of IoT is the narrowband-IoT (NB-IoT). Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum, called MulteFire. Further enhanced operation of LTE systems in the licensed as well as unlicensed spectrum is expected in future releases and 5G systems. Such enhanced operations can include techniques for sidelink resource allocation and UE processing behaviors for NR sidelink V2X communications.

An NG system architecture (or 6G system architecture) can include the RAN 110 and a core network (CN) 120. The NG-RAN 110 can include a plurality of nodes, such as gNBs and NG-eNBs. The CN 120 (e.g., a 5G core network (5GC)) can include an access and mobility function (AMF) and/or a user plane function (UPF). The AMF and the UPF can be communicatively coupled to the gNBs and the NG-eNBs via NG interfaces. More specifically, in some aspects, the gNBs and the NG-eNBs can be connected to the AMF by NG-C interfaces, and to the UPF by NG-U interfaces. The gNBs and the NG-eNBs can be coupled to each other via Xn interfaces.

In some aspects, the NG system architecture can use reference points between various nodes. In some aspects, each of the gNBs and the NG-eNBs can be implemented as a base station, a mobile edge server, a small cell, a home eNB, and so forth. In some aspects, a gNB can be a master node (MN) and NG-eNB can be a secondary node (SN) in a 5G architecture.

FIG. 1B illustrates a non-roaming 5G system architecture in accordance with some aspects. In particular, FIG. 1B illustrates a 5G system architecture 140B in a reference point representation, which may be extended to a 6G system architecture. More specifically, UE 102 can be in communication with RAN 110 as well as one or more other CN network entities. The 5G system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 can be used to manage access control and mobility and can also include network slice selection functionality. The AMF 132 may provide UE-based authentication, authorization, mobility management, etc., and may be independent of the access technologies. The SMF 136 can be configured to set up and manage various sessions according to network policy. The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple 5G sessions. Different SMFs may be allocated to each session. The use of different SMFs may permit each session to be individually managed. As a consequence, the functionalities of each session may be independent of each other.

The UPF 134 can be deployed in one or more configurations according to the desired service type and may be connected with a data network. The PCF 148 can be configured to provide a policy framework using network slicing, mobility management, and roaming (similar to PCRF in a 4G communication system). The UDM can be configured to store subscriber profiles and data (similar to an HSS in a 4G communication system).

The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for UE authentication.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162BE, a serving CSCF (S-CSCF) 164B, an emergency CSCF (E-CSCF) (not illustrated in FIG. 1B), or interrogating CSCF (I-CSCF) 166B. The P-CSCF 162B can be configured to be the first contact point for the UE 102 within the IM subsystem (IMS) 168B. The S-CSCF 164B can be configured to handle the session states in the network, and the E-CSCF can be configured to handle certain aspects of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some aspects, the I-CSCF 166B can be connected to another IP multimedia network 170B, e.g. an IMS operated by a different network operator.

In some aspects, the UDM/HSS 146 can be coupled to an application server (AS) 160B, which can include a telephony application server (TAS) or another application server. The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures can be service-based and interaction between network functions can be represented by corresponding point-to-point reference points Ni or as service-based interfaces.

In some aspects, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

NR-V2X architectures may support high-reliability low latency sidelink communications with a variety of traffic patterns, including periodic and aperiodic communications with random packet arrival time and size. Techniques disclosed herein can be used for supporting high reliability in distributed communication systems with dynamic topologies, including sidelink NR V2X communication systems.

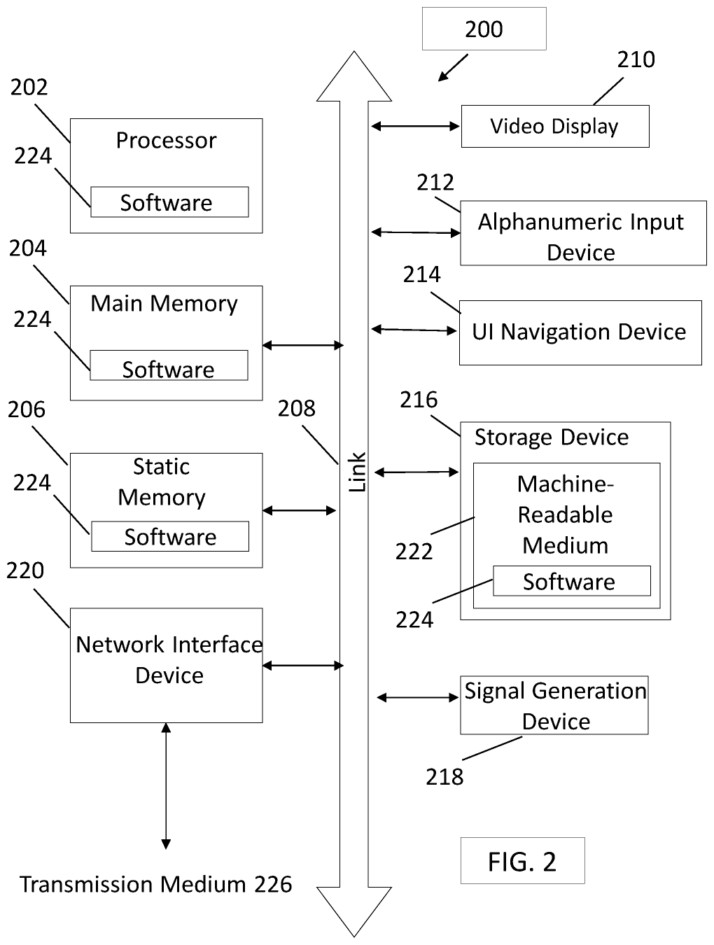

FIG. 2 illustrates a block diagram of a communication device in accordance with some embodiments. The communication device 200 may be a UE such as a specialized computer, a personal or laptop computer (PC), a tablet PC, or a smart phone, dedicated network equipment such as an eNB, a server running software to configure the server to operate as a network device, a virtual device, or any machine capable of executing instructions (sequential or otherwise) that specify actions to be taken by that machine. For example, the communication device 200 may be implemented as one or more of the devices shown in FIGS. 1A-1C. Note that communications described herein may be encoded before transmission by the transmitting entity (e.g., UE, gNB) for reception by the receiving entity (e.g., gNB, UE) and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or other sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a next generation (NG)/5th generation (5G) standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 5G, 5G New Radio (5G NR), 3GPP 5G New Radio, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Zigbee, Bluetooth®, Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V2I) and Infrastructure-to-Vehicle (12V) communication technologies, 3GPP cellular V2X, DSRC (Dedicated Short Range Communications) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety re-lated applications in the frequency range 5,875 GHz to 5,905 GHZ), ITS-G5B (i.e., Operation in European ITS frequency bands dedicated to ITS non-safety applications in the frequency range 5,855 GHz to 5,875 GHz), ITS-G5C (i.e., Operation of ITS applications in the frequency range 5,470 GHz to 5,725 GHZ)), DSRC in Japan in the 700 MHz band (including 715 MHz to 725 MHz), IEEE 802.11bd based systems, etc.

Aspects described herein can be used in the context of any spectrum management scheme including dedicated licensed spectrum, unlicensed spectrum, license exempt spectrum, (licensed) shared spectrum (such as LSA=Licensed Shared Access in 2.3-2.4 GHz, 3.4-3.6 GHZ, 3.6-3.8 GHz and further frequencies and SAS=Spectrum Access System/CBRS=Citizen Broadband Radio System in 3.55-3.7 GHZ and further frequencies). Applicable spectrum bands include IMT (International Mobile Telecommunications) spectrum as well as other types of spectrum/bands, such as bands with national allocation (including 450-470 MHz, 902-928 MHz (note: allocated for example in US (FCC Part 15)), 863-868.6 MHz (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHz (note: allocated for example in China), 790-960 MHZ, 1710-2025 MHz, 2110-2200 MHz, 2300-2400 MHZ, 2.4-2.4835 GHz (note: it is an ISM band with global availability and it is used by Wi-Fi technology family (11b/g/n/ax) and also by Bluetooth), 2500-2690 MHZ, 698-790 MHZ, 610-790 MHz, 3400-3600 MHZ, 3400-3800 MHZ, 3800-4200 MHz, 3.55-3.7 GHZ (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHZ (note: allocated for example in South Korea, 5925-7125 MHz and 5925-6425 MHz band (note: under consideration in US and EU, respectively. Next generation Wi-Fi system is expected to include the 6 GHz spectrum as operating band but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHZ, 3800-4200 MHZ, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHZ, 31-31.3 GHZ, 37-38.6 GHZ, 38.6-40 GHz, 42-42.5 GHz, 57-64 GHz, 71-76 GHz, 81-86 GHz and 92-94 GHZ, etc), the ITS (Intelligent Transport Systems) band of 5.9 GHz (typically 5.85-5.925 GHZ) and 63-64 GHz, bands currently allocated to WiGig such as WiGig Band 1 (57.24-59.40 GHZ), WiGig Band 2 (59.40-61.56 GHZ) and WiGig Band 3 (61.56-63.72 GHZ) and WiGig Band 4 (63.72-65.88 GHz), 57-64/66 GHz (note: this band has near-global designation for Multi-Gigabit Wireless Systems (MGWS)/WiGig. In US (FCC part 15) allocates total 14 GHz spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHz, and future bands including 94-300 GHz and above. Furthermore, the scheme can be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

Aspects described herein can also implement a hierarchical application of the scheme is possible, e.g., by introducing a hierarchical prioritization of usage for different types of users (e.g., lowithmedium/high priority, etc.), based on a prioritized access to the spectrum e.g., with highest priority to tier-1 users, followed by tier-2, then tier-3, etc. users, etc.

Aspects described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.

5G networks extend beyond the traditional mobile broadband services to provide various new services such as internet of things (IoT), industrial control, autonomous driving, mission critical communications, etc. that may have ultra-low latency, ultra-high reliability, and high data capacity requirements due to safety and performance concerns. Some of the features in this document are defined for the network side, such as APs, eNBs, NR or gNBs note that this term is typically used in the context of 3GPP 5G and 6G communication systems, etc. Still, a UE may take this role as well and act as an AP, eNB, or gNB; that is some or all features defined for network equipment may be implemented by a UE.

As above, mobile communication has evolved significantly from early voice systems to today's highly sophisticated integrated communication platform. The next generation wireless communication system, 5G, or new radio (NR) is to provide access to information and sharing of data anywhere, anytime by various users and applications. NR is to be a unified network/system whose target is to meet vastly different and sometime conflicting performance dimensions and services. Such diverse multi-dimensional requirements are driven by different services and applications.

NR supports a wide range of spectrum in different frequency ranges. It is expected that there will be increasing availability of spectrum in the market for 5G Advanced possibly due to re-farming from the bands originally used for previous cellular generation networks. Especially for frequency range 1 (FR1) bands, the available spectrum blocks tend to be more fragmented and scattered with narrower bandwidth. For FR2 bands and some FR1 bands, the available spectrum can be wider such that intra-band multi-carrier operation is to be used. To meet different spectrum needs, the scattered spectrum bands or wider bandwidth spectrum should be able to be utilized in a more spectral/power efficient and flexible manner, thus providing higher throughput and decent coverage in the network.

One motivation is to increase flexibility and spectral/power efficiency on scheduling data over multiple cells including intra-band cells and inter-band cells. The current scheduling mechanism only allows scheduling of single cell physical uplink shared channel (PUSCH)/physical downlink shared channel (PDSCH) per a scheduling downlink control information (DCI). With more available scattered spectrum bands or wider bandwidth spectrum, the desire for simultaneous scheduling of multiple cells is expected to increase. To reduce the control overhead, it is beneficial to extend from single-cell scheduling to multi-cell PUSCH/PDSCH scheduling with a single scheduling DCI. More specifically, a DCI is used to schedule PDSCH or PUSCH transmissions in more than one cell or component carrier (CC), where each PDSCH or PUSCH is scheduled in one cell or CC.

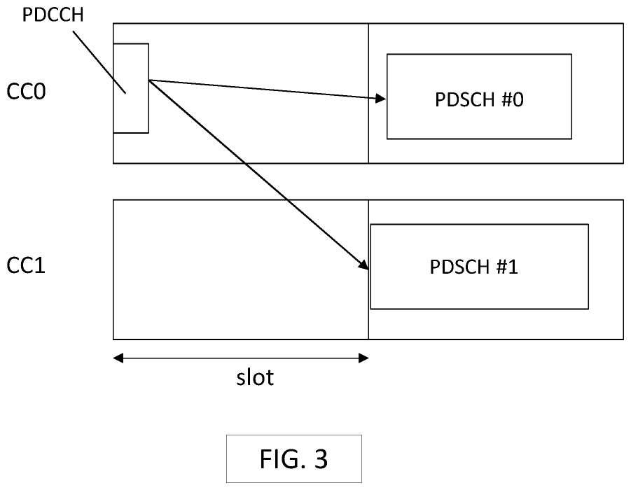

FIG. 3 illustrates multi-cell scheduling for a PDSCH in accordance with some embodiments. one example of multi-cell scheduling for PDSCHs. As shown in FIG. 3, one physical downlink control channel (PDCCH) is used to schedule two PDSCHs in two different cells, i.e., PDSCH #0 in CC0 and PDSCH #1 in CC1.

As defined in Rel-15/16, for single cell scheduling, the following fields, if applicable, are used to indicate the time and frequency resource allocated for PDSCH and PUSCH transmission: a carrier indicator is used to indicate the component carrier index in case of cross carrier scheduling; a bandwidth part (BWP) indicator is used to activate one of the BWPs which are configured by higher layers; a time domain resource assignment is used to indicate the resource allocation in the time domain, including a slot offset between scheduling PDCCH and scheduled PDSCH or PUSCH, starting and length indicator value (SLIV) in the allocated slot, mapping type A or B; a frequency domain resource assignment is used to indicate the resource allocation in the frequency domain, i.e., which physical resource blocks (PRB) in active BWP are used for the PDSCH or PUSCH transmission; an uplink/supplementary uplink (UL/SUL) indicator is used to indicate whether supplementary uplink cell is used for uplink transmission.

For multi-cell scheduling, the DCI payload size increases substantially if the above fields are included separately in the DCI for resource allocation of PDSCHs or PUSCHs in different cells. In order to address this issue while maintaining scheduling flexibility, certain mechanisms may be defined for the resource allocation of PDSCH or PUSCH transmissions in case of multi-cell scheduling. Mechanisms are disclosed herein on resource allocation for PDSCH or PUSCH transmissions with multi-cell scheduling. The mechanisms may include, in particular, a carrier indicator for multi-cell scheduling; a BWP indication for multi-cell scheduling; an UL/SUL indicator for multi-cell scheduling; a frequency domain resource allocation (FDRA) for multi-cell scheduling; and a TDRA for multi-cell scheduling.

### Carrier Indicator for Multi-Cell Scheduling

Embodiments of carrier indicator for multi-cell scheduling are as follows:

In one embodiment, for multi-cell scheduling, a carrier indication bitmap may be included to indicate the scheduled cell. The bitmap size can be determined in accordance with the number of configured cells for multi-cell scheduling. In particular, bit “1” in the bitmap may be used to indicate that the cell is scheduled with a PDSCH or PUSCH transmission, while bit “0” in the bitmap may be used to indicate that the cell is not scheduled with a PDSCH or PUSCH transmission.

Note that for this option, when only one bit is indicated with “1” in the bitmap, this may indicate that the DCI is used for single-cell scheduling.

In one example, assuming 4 cells are configured for multi-cell scheduling, a bitmap “1100” in the DCI may be used to indicate that the first and second cell are scheduled for PDSCH or PUSCH transmissions.

In another embodiment, a carrier indication table may be configured by higher layers via NR remaining minimum system information (RMSI), NR other system information (OSI) or dedicated radio resource control (RRC) signaling, dynamically indicated in the DCI, or a combination thereof. In particular, each row of the carrier indication table can indicate a set of carriers that are scheduled by a multi-cell scheduling DCI.

In one option, the carrier indication table can be configured by dedicated RRC signaling, and one field in the DCI can be used to indicate which row is used to indicate the set of carriers for multi-cell scheduling. Note that the carrier indication table may be configured for a scheduling cell.

Note that the carrier indication field in the DCI may be applied for all the scheduled cells or a cell in a cell group. In the latter case, a Ngroup carrier indication field can be included in the DCI, where each carrier indication field is used to indicate the cell index for each cell group, and Ngroup is the number of cell groups for multi-cell scheduling.

In another option, in the carrier indication table, each row can indicate the cell index and the association between cell index and cell group index. Based on the carrier indication field in the DCI for multi-cell scheduling, the UE determines the cell index and associated cell group index for PUSCH and PDSCH transmissions.

Table 1 illustrates one example of carrier indication table for multi-cell scheduling. In the example, 8 cells are configured for multi-cell scheduling. Further, 8 entries for the carrier indication are configured by RRC signaling. In this case, a 3-bit field in the DCI can be used to select one row of the table for carrier indication for multi-cell scheduling.

TABLE 1
Carrier indication table for multi-cell scheduling

| Carrier indication index | Scheduled serving cell index |
|---|---|
| 0 | 0, 1 |
| 1 | 2, 3 |
| 2 | 4, 5 |
| 3 | 6, 7 |
| 4 | 0, 1, 2, 3 |
| 5 | 4, 5, 6, 7 |
| 6 | 0, 1, 4, 5 |
| 7 | 2, 3, 6, 7 |

In another embodiment, carrier indication table for multi-cell scheduling can be jointly configured with that for single-cell scheduling. In this case, the gNB may dynamically switch from single-cell scheduling and multi-cell scheduling based on the carrier indication field in the DCI. In the carrier indication table, first K rows can be configured for single-cell scheduling, where the remaining row can be configured for multi-cell scheduling.

Table 2 illustrates one example of single-cell scheduling and multi-cell scheduling. In the example, 8 cells are configured for multi-cell scheduling. Further, the first 8 entries for the carrier indication are configured for single cell scheduling and remaining 8 entries are configured for multi-cell scheduling. In this case, a 4-bit field in the DCI can be used to select one row of the table for carrier indication for both single cell scheduling and multi-cell scheduling.

TABLE 2
Carrier indication table for single-cell
scheduling and multi-cell scheduling

| Carrier indication index | Scheduled serving cell index |
|---|---|
| 0 | 0 |
| 1 | 1 |
| 2 | 2 |
| 3 | 3 |
| 4 | 4 |
| 5 | 5 |
| 6 | 6 |
| 7 | 7 |
| 8 | 0, 1 |
| 9 | 2, 3 |
| 10 | 4, 5 |
| 11 | 6, 7 |
| 12 | 0, 1, 2, 3 |
| 13 | 4, 5, 6, 7 |
| 14 | 0, 1, 4, 5 |
| 15 | 2, 3, 6, 7 |

In another embodiment, one field in the DCI may be included to explicitly indicate whether the DCI is for single cell scheduling or multi-cell scheduling. Based on the indication and configured carrier indication table, the UE can determine which carriers are scheduled for PDSCH or PUSCH transmission. In one example, bit “1” may be used to indicate that the DCI is used for multi-cell scheduling and bit “0’ is used to indicate that the DCI is used for single cell scheduling.

### BWP Indicator for Multi-Cell Scheduling

Embodiments of BWP indicator for multi-cell scheduling are as follows:

In one embodiment, for multi-cell scheduling, a BWP bitmap is used to indicate the BWP index for the scheduled cells or configured cells for multi-cell scheduling. Note that the size of BWP bitmap may be determined in accordance with the number of configured cells for multi-cell scheduling and the number of BWPs configured for each serving cell.

In one example, 2 cells are configured for multi-cell scheduling. In the first cell, the number of DL BWPs is configured as 2 while in the second cell, the number of DL BWPs is configured as 4. In this case, the BWP bitmap size is 3 bits, where the first bit is used to indicate the BWP index for the first cell and the last two bits are used to indicate the BWP index for the second cell.

In another embodiment, for multi-cell scheduling, a BWP table may be configured by dedicated RRC signaling, and a single BWP indication field in the DCI may be used to indicate the BWP index for the scheduled cell for PDSCH or PUSCH transmission according to the BWP table. Note that for this option, the configured or scheduled carrier index and BWP index have one to one mapping in a sequential order. Further, the number of indicated BWP indexes is equal to the number of indicated carrier indexes.

In embodiments in which the number of indicated BWP indexes is less than the number of indicated carrier indexes, only the first K indicated carrier indexes are valid, where K is the number of indicated BWP indexes, or the BWP indexes are determined in accordance with the corresponding indicated carrier indexes.

Similarly, in embodiments in which the number of indicated carrier indexes is less than the number of indicated BWP indexes, only the first M indicated BWP indexes are valid, where M is the number of indicated carrier indexes, or the BWP indexes are determined in accordance with the corresponding indicated carrier indexes.

Table 3 illustrates one example of a BWP indication table for multi-cell scheduling. In the example, 8 cells are configured for multi-cell scheduling. Further, 8 entries for the BWP indication are configured by RRC signaling. In this case, a 3-bit field in the DCI can be used to select one row of the table for the BWP indication for multi-cell scheduling.

TABLE 3
BWP indication table for multi-cell scheduling

| BWP indication index | BWP index in the scheduled serving cell |
|---|---|
| 0 | 0, 0 |
| 1 | 1, 1, |
| 2 | 0, 1 |
| 3 | 1, 3 |
| 4 | 0, 0, 0, 0 |
| 5 | 1, 1, 1, 1 |
| 6 | 0, 1, 0, 1 |
| 7 | 1, 3, 1, 2 |

In another option, the BWP indication table may be configured for both single-cell and multi-cell scheduling. In this case, the first M_{single} TOWS can be used to indicate the BWP index for single cell scheduling and remaining rows can be used to indicate the BWP indexes for multi-cell scheduling.

Table 4 illustrates one example of a BWP indication table for single cell and multi-cell scheduling. In the example, 8 cells are configured for multi-cell scheduling. Further, first 8 entries are used for the BWP indication for the single-cell scheduling while the last 8 entries are used for the BWP indication for the multi-cell scheduling. In this case, a 4-bit field in the DCI can be used to select one row of the table for the BWP indication for both single cell and multi-cell scheduling.

TABLE 4
BWP indication table for single cell and multi-cell scheduling

| BWP indication index | BWP index in the scheduled serving cell |
|---|---|
| 0 | 0 |
| 1 | 1 |
| 2 | 0 |
| 3 | 1 |
| 4 | 0 |
| 5 | 1 |
| 6 | 0 |
| 7 | 1 |
| 8 | 0, 0 |
| 9 | 1, 1, |
| 10 | 0, 1 |
| 11 | 1, 3 |
| 12 | 0, 0, 0, 0 |
| 13 | 1, 1, 1, 1 |
| 14 | 0, 1, 0, 1 |
| 15 | 1, 3, 1, 2 |

In another embodiment, for multi-cell scheduling, a single BWP indication field is used to indicate the BWP index for the scheduled cells or the cells in a cell group. Further, the BWP indication field size is determined in accordance with the maximum or minimum number of BWPs configured among the configured cells for multi-cell scheduling.

When the BWP indication field size is determined in accordance with the maximum number of BWPs configured among the configured cells, and when the determined BWP field size for a scheduled cell is less than the single BWP indication field size in the DCI, truncation is applied on the single BWP indication field size to match with the determined BWP field size for the scheduled cell. In this case, the UE uses a number of least significant bits of the BWP indication field that is equal to the one for the determined BWP field size for a scheduled cell.

When the BWP indication field size is determined in accordance with the minimum number of BWPs configured among the configured cells, and when the determined BWP field size for a scheduled cell is greater than the single BWP indication field size in the DCI, zero padding is applied on the single BWP indication field size to match with the determined BWP field size for the scheduled cell. In this case, the UE prepends zeros to the BWP indication field until the size is equal to the one for the determined BWP field size for a scheduled cell.

In another embodiment, for multi-cell scheduling, a joint carrier indication and BWP indication table can be configured by dedicated RRC signaling and one field in the DCI may be used to select one row of the table for both carrier and BWP indication.

Table 5 illustrates one example of carrier and BWP indication table for multi-cell scheduling. In the example, 4 cells are configured in which each cell is configured with 2 BWPs for multi-cell scheduling. Further, 8 entries for the carrier and BWP indication are configured by RRC signaling. In this case, a 3-bit field in the DCI can be used to select one row of the table for both carrier and BWP indication for multi-cell scheduling.

TABLE 5
Carrier and BWP indication table for multi-cell scheduling

| Carrier and BWP | Scheduled serving cell and BWP |
|---|---|
| indication index | index in the scheduled serving cell |
| 0 | {Serving cell ID = 0, BWP ID = 0}, |
| | {Serving cell ID = 1, BWP ID = 0}, |
| 1 | {Serving cell ID = 0, BWP ID = 1}, |
| | {Serving cell ID = 1, BWP ID = 1}, |
| 2 | {Serving cell ID = 2, BWP ID = 0}, |
| | {Serving cell ID = 3, BWP ID = 0}, |
| 3 | {Serving cell ID = 2, BWP ID = 1}, |
| | {Serving cell ID = 3, BWP ID = 1}, |
| 4 | {Serving cell ID = 0, BWP ID = 0}, |
| | {Serving cell ID = 1, BWP ID = 0}, |
| | {Serving cell ID = 2, BWP ID = 0}, |
| | {Serving cell ID = 3, BWP ID = 0}, |
| 5 | {Serving cell ID = 0, BWP ID = 1}, |
| | {Serving cell ID = 1, BWP ID = 1}, |
| | {Serving cell ID = 2, BWP ID = 1}, |
| | {Serving cell ID = 3, BWP ID = 1}, |
| 6 | {Serving cell ID = 0, BWP ID = 0}, |
| | {Serving cell ID = 1, BWP ID = 1}, |
| | {Serving cell ID = 2, BWP ID = 0}, |
| | {Serving cell ID = 3, BWP ID = 1}, |
| 7 | {Serving cell ID = 0, BWP ID = 1}, |
| | {Serving cell ID = 1, BWP ID = 0}, |
| | {Serving cell ID = 2, BWP ID = 1}, |
| | {Serving cell ID = 3, BWP ID = 0}, |

In another option, the carrier and BWP indication table may be configured for both single-cell and multi-cell scheduling. In this case, the first M_{single} rows can be used to indicate the carrier and BWP index for single cell scheduling and remaining rows can be used to indicate the carrier and BWP indexes for multi-cell scheduling.

Note that for the above embodiments, the number of BWPs for single cell scheduling may be separately configured from that for multi-cell scheduling. For example, 4 BWPs are configured for single-cell scheduling, however, only two of the 4 BWPs can be indicated by multi-cell scheduling. The two BWPs that can be schedulable by multi-cell scheduling may correspond to any two BWP indexes. Further, the BWP or joint carrier and BWP indication table may be configured per cell group. In one example, the same number of BWPs may be configured for each configured cell for multi-cell scheduling.

In another embodiment, the BWP indication field is not included in the multi-cell scheduling. This indicates that BWP adaptation is not supported for the multi-cell scheduling and the active BWP on the scheduled cell is used for PDSCH or PUSCH transmission.

Note that for the above embodiments, the number of entries for carrier and/or BWP indication can be configured by higher layers by RRC signaling. In this case, the number of bits for the corresponding field in the DCI can be determined accordingly.

### UL/SUL Indicator for Multi-Cell Scheduling

Embodiments of UL/SUL indicator for multi-cell scheduling are as follows:

In one embodiment, for multi-cell scheduling, the UL/SUL indicator is not present regardless of whether the UE is configured with supplementaryUplink in ServingCellConfig in the cell. In this case, SUL is not supported for multi-cell scheduling for PUSCH transmissions.

### FDRA for Multi-Cell Scheduling

Embodiments of FDRA for multi-cell scheduling are as follows:

In one embodiment, for multi-cell scheduling, the UE is configured with same resource allocation (RA) type for the resource allocation in frequency domain for all the scheduled cells or the cells in a same cell group. In embodiments in which more than one cell group is used for multi-cell scheduling, the UE may be configured with N_{Cell}^{group} RA types, where each RA type is commonly applied for the scheduled cells in each cell group; and N_{Cell}^{group} is the number of cell groups for multi-cell scheduling.

In one example, the UE is configured with only RA type 0 or RA type 1 for multi-cell PDSCH scheduling. In another example, the UE is configured with both RA type 0 and RA type 1 for multi-cell PDSCH scheduling. Further, one bit in the DCI is used to dynamically switch between RA type 0 and type 1 for FDRA for all the scheduled cells or the cells in a same cell group.

For this option, for multi-cell scheduling, the configuration of the RA type can override the configuration for single-cell scheduling. Further, separate configurations of RA types may be configured for PDSCH and PUSCH transmission.

In another embodiment, for multi-cell scheduling, a common FDRA field is applied for all the scheduled cells or the cells in a cell group. Further, the FDRA field size is determined in accordance with the bandwidth of a reference BWP in a cell. In particular, the reference BWP of a cell can be determined based on one or more following options: a BWP in all configured BWPs or indicated BWPs in all configured or scheduled cells with largest bandwidth; a BWP in all configured or indicated BWPs in all configured or scheduled cells with smallest bandwidth; a BWP in the default BWPs in all configured or scheduled cells with largest bandwidth; a BWP in the default BWPs in all configured or scheduled cells with smallest bandwidth; a BWP in the initial BWPs in all configured or scheduled cells with largest bandwidth; a BWP in the initial BWPs in all configured or scheduled cells with smallest bandwidth; a BWP in active BWPs in all configured or scheduled cells with largest bandwidth; a BWP in active BWPs in all configured or scheduled cells with smallest bandwidth; a BWP in all configured BWPs or indicated BWPs in all configured or scheduled cells with largest number of Resource Block Groups (RBGs) with FDRA type 0; a BWP in all configured or indicated BWPs in all configured or scheduled cells with smallest number of RBGs with FDRA type 0; a BWP in the default BWPs in all configured or scheduled cells with largest number of RBGs with FDRA type 0; a BWP in the default BWPs in all configured or scheduled cells with smallest number of RBGs with FDRA type 0; a BWP in the initial BWPs in all configured or scheduled cells with largest number of RBGs with FDRA type 0; a BWP in the initial BWPs in all configured or scheduled cells with smallest number of RBGs with FDRA type 0; a BWP in active BWPs in all configured or scheduled cells with largest number of RBGs with FDRA type 0; a BWP in active BWPs in all configured or scheduled cells with smallest number of RBGs with FDRA type 0; or the active BWP for the scheduling cell.

Note that for the above options, all configured BWPs or configured cells may be only for multi-cell scheduling. Further, the reference BWP of a cell can be determined separately for DL and UL, respectively. If the reference BWP is determined by the active BWPs of all configured cells, the considered active BWP of a deactivated cell can be the DL BWP with index provided by firstActiveDownlinkBWP-Id for the deactivated cell, and the UL BWP with index provided by firstActive UplinkBWP-Id for the deactivated cell.

In one option, when the size of the common FDRA field is greater than the determined FDRA field size for an active or indicated BWP of the scheduled cell, truncation is applied on the common FDRA field size to match with the determined FDRA field size for an active or indicated BWP of the scheduled cell. In this case, the UE uses a number of least significant bits of the common FDRA field which is equal to the one for the determined FDRA field size for an active or indicated BWP of the scheduled cell.

When the size of common FDRA field is less than the determined FDRA field size for an active or indicated BWP of the scheduled cell, zero padding is applied on the common FDRA field size to match with the determined FDRA field size for an active or indicated BWP of the scheduled cell. In this case, the UE prepends zeros to the common FDRA field until the size is equal to the one for the determined FDRA field size for an active or indicated BWP of the scheduled cell.

In another embodiment, when the RA type for PDSCH or PUSCH transmission is configured or indicated as RA type 0, if the BW of the indicated or active BWP is different from the BW of the reference BWP of the scheduled cell as mentioned above, a scaling factor can be determined and applied to the FDRA of the indicated or active BWP for PDSCH or PUSCH transmission.

In one option, assuming a reference BWP with total number of Resource Block Groups (RBGs) N_{RBG}^{refer}, and an indicated or active BWP of another cell with total number of RBGs N_{RBG}^{active}, if N_{RBG}^{active}>N_{RBG}^{refer}, K is the maximum value from set {1, 2, 4, 8} that satisfies K≤└N_{RBG}^{active}/N_{RBG}^{refer}┘; otherwise K=1.

Based on the determined scaling factor K, the UE can apply K·P^{active} to determine the frequency resource allocation for indicated or active BWP for PDSCH or PUSCH transmission, where P^{active} is the PRBG value for the indicated or active BWP.

In another option, assuming a reference BWP with total number of Resource Block Groups (RBGs) N_{RBG}^{refer}, and an indicated or active BWP of another cell with total number of RBGs N_{RBG}^{active}, if N_{RBG}^{active}>N_{RBG}^{refer}, K is the maximum value from set {1, 2, 4, 8} which satisfies K≤└N_{RBG}^{active}/N_{RBG}^{refer}┘: if N_{RBG}^{active}≤N_{RBG}^{refer}, K is the maximum value from predefined set, e.g., {1, ½, ¼, ⅛} that satisfies K≤└N_{RBG}^{active}/N_{RBG}^{refer}┘. Based on the determined scaling factor K, the UE can apply max (K·P^{active}, 1) to determine the frequency resource allocation for indicated or active BWP for PDSCH or PUSCH transmission, where P^{active} is the PRBG value for the indicated or active BWP.

In another option, assuming a reference BWP with total number of Resource Block Groups (RBGs) N_{RBG}^{refer}, and an indicated or active BWP of another cell with total number of RBGs N_{RBG}^{active}, if N_{RBG}^{active}>N_{RBG}^{refer}, a maximum value K, K≥1 is determined that satisfies K≤└N_{RBG}^{active}/N_{RBG}^{refer}┘; if N_{RBG}^{active}≤N_{RBG}^{refer}, K is the maximum value from predefined set, e.g., {1, ½, ¼, ⅛} that satisfies K≤└N_{RBG}^{active}/N_{RBG}^{refer}┘. Based on the determined scaling factor K, the UE can apply max (K·P^{active}, 1) to determine the frequency resource allocation for indicated or active BWP for PDSCH or PUSCH transmission, where P^{active} is the PRBG value for the indicated or active BWP.

In another embodiment, in another option, assuming a reference BWP with total number of Resource Block Groups (RBGs) N_{RBG}^{refer}, and an indicated or active BWP of another cell with BWP size of N_{BWP}^{active}, a maximum value K, K≥1 is determined that satisfies K≤└N_{BWP}^{active}/N_{RBG}^{refer}┘. Alternatively, a maximum value K, K≥1 is determined which satisfies K≤┌N_{BWP}^{active}/N_{RBG}^{refer}┐. The UE can apply a RBG size of K to determine the frequency resource allocation for indicated or active BWP for PDSCH or PUSCH transmission.

In another embodiment, assuming a reference BWP with size of N_{BWP}^{refer} and an indicated or active BWP of another cell with size of N_{BWP}^{active}, a PRB index k on the indicated or active BWP maps to a PRB index m on the reference BWP. For example, m=└k·N_{BWP}^{refer}/N_{BWP}^{active}┘, k=0, 1, . . . , N_{BWP}^{active}−1. Then, based on an indicated FDRA value of RA type 0, if a RBG on the reference BWP is indicated, the PRBs on the indicated or active BWP that are mapped to the PRBs in the RBG on the reference BWP are allocated on the indicated or active BWP.

In another embodiment, when the RA type for PDSCH or PUSCH transmission is configured or indicated as RA type 1, if the BW of the indicated or active BWP is different from the BW of the reference BWP of the scheduled cell as mentioned above, a scaling factor can be determined and applied to the FDRA of the indicated or active BWP for PDSCH or PUSCH transmission.

Assuming a reference BWP with size of N_{BWP}^{refer} and an indicated or active BWP of another cell with size of N_{BWP}^{active}, an uplink type 1 resource block assignment field has a resource indication value (RIV) corresponding to a starting resource block RBₛₜₐᵣₜ=0, K, 2·K, . . . , (N_{BWP}^{refer}−1)·K and a length in terms of virtually contiguously allocated resource blocks L_{RBs}=K,2·K, . . . , N_{BWP}^{refer}·K.

The resource indication value is defined by:

$$if ( {L}_{R B s}^{′} - 1 ) \leq ⌊ {N}_{B W P}^{refer} / 2 ⌋ then$$

$$RIV = {N}_{B W P}^{refer} ( {L}_{R B s}^{′} - 1 ) + {RB}_{s t a r t}^{′}$$

$$else RIV = {N}_{B W P}^{refer} ( {N}_{B W P}^{refer} - {L}_{R B s}^{′} + 1 ) + ( {N}_{B W P}^{refer} - 1 - {RB}_{s t a r t}^{′} )$$

$$where {L}_{R B s}^{′} = \frac{{L}_{R B s}^{′}}{K} , {RB}_{start}^{′} = \frac{R {B}_{start}}{K}$$

and where L′_{RBs} shall not exceed N_{BWP}^{refer}−RB′ₛₜₐᵣₜ.

If N_{BWP}^{active}>N_{BWP}^{refer}, K is the maximum value from set {1, 2, 4, 8} that satisfies K≤└N_{BWP}^{active}/N_{BWP}^{initial}┘; otherwise K=1.

In another option, if N_{BWP}^{active}≤N_{BWP}^{refer}, K is the maximum value from set {1, 2, 4, 8} that satisfies K≤└N_{BWP}^{refer}/N_{BWP}^{refer}┘;

In another option, if N_{BWP}^{active}≤N_{BWP}^{refer}, K is the maximum value from a predefined set, e.g., {½, ¼, ⅛} that satisfies K≤

$$K \leq ⌊ \frac{{N}_{BWP}^{active}}{{N}_{BWP}^{initial}} ⌋$$

In another embodiment, assuming a reference BWP with size of N_{BWP}^{refer} and an indicated or active BWP of another cell with size of N_{BWP}^{active}, a PRB index k on the indicated or active BWP maps to a PRB index m on the reference BWP. For example, m=└k·N_{BWP}^{refer}/N_{BWP}^{active}┘, k=0, 1, . . . , N_{BWP}^{active}−1. Then, for a downlink type 1 resource allocation field having a resource indication value (RIV) corresponding to a starting virtual resource block (RBₛₜₐᵣₜ) and a length in terms of contiguously allocated resource blocks L_{RBs} on the reference BWP, the allocated PRBs on the indicated or active BWP are the PRBs on the indicated or active BWP that are mapped to the L_{RBs} PRBs on the reference BWP.

In another embodiment, the aforementioned embodiments can be applied for the first step on the determination of frequency resource allocation for the active BWP for the scheduled cell. Further, the existing mechanism defined in Section 12 in TS 38.213 can be reused to determine the frequency resource allocation of the indicated BWP.

In another embodiment, a single step based on the aforementioned embodiments is used to determine the frequency resource allocation of the indicated BWP for multi-cell scheduling.

In particular, a common FDRA field is applied for all the scheduled cells or the cells in a cell group, where the FDRA field size is determined in accordance with the bandwidth of a reference BWP in a cell. Based on the aforementioned embodiments, the frequency resource allocation for the indicated BWP or active BWP for the scheduled cell can be determined in accordance with the number of PRBs of the reference BWP, the number of PRBs of the reference BWP for the indicated BWP or active BWP, and indicated FDRA field.

### TDRA for Multi-Cell Scheduling

Embodiments of TDRA for multi-cell scheduling are as follows:

In one embodiment, for multi-cell scheduling, N_{Cell} TDRA fields can be included in the DCI and applied to the PDSCHs or PUSCHs in N_{Cell} cells scheduled by the DCI. Alternatively, N_{Cell}^{group} TDRA fields can be included in the DCI and each TDRA field is jointly applied to the PDSCHs or PUSCHs in the cells in a cell group scheduled by the DCI, where N_{Cell}^{group} is the number of cell groups for multi-cell scheduling. Note that when N_{Cell}^{group}=1, this indicates that all the cells are in a cell group.

In one option, the TDRA table that is used in the DCI for multi-cell scheduling can reuse the configuration of the TDRA table for single cell scheduling for the scheduled cell.

In another option, the TDRA table that is used in the DCI for multi-cell scheduling can be separately configured from the TDRA table that is used for the single cell scheduling.

In another embodiment, for multi-cell scheduling, a row of the TDRA table can indicate PDSCHs or PUSCHs that are in different cells, by configuring {SLIV, mapping type, scheduling offset K0 or K2} for each PDSCH or PUSCH in each scheduled cell in the row of TDRA table. Note that scheduling offset k0 or k2 can be defined in accordance with the subcarrier spacing (SCS) of the scheduled cell.

For this option, the cell index for the PDSCH or PUSCH transmission can be indicated separately in the scheduling DCI, e.g., in the carrier indicator field. Note that the number of PDSCHs or PUSCHs determined from the row of the TDRA table may have one to one mapping to the number of determined cells. In other words, the UE expects the number of scheduled PDSCHs or PUSCHs is same as the number of determined cells.

In embodiments in which the number of PDSCHs or PUSCHs determined from the row of the TDRA table is greater than the number of determined cells, only the first N_{Cell} PDSCHs or PUSCHs are valid in the row of the TDRA table, where N_{Cell} is the number of determined cells.

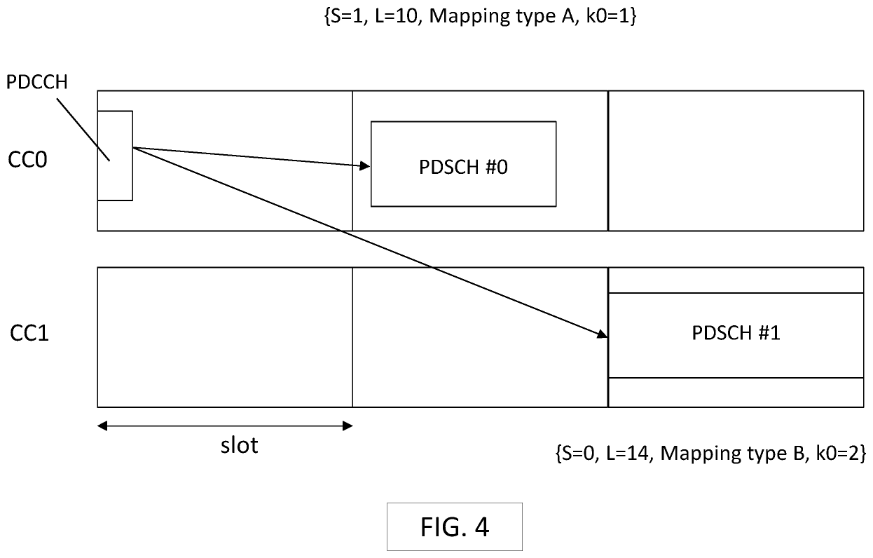

FIG. 4 illustrates a TDRA indication for multi-cell scheduling in accordance with some embodiments. In FIG. 4, a DCI is used to schedule PDSCHs in two cells. Further, the indicated row of the TDRA table includes {S=1, L=10, Mapping type A, k0=1} for the PDSCH #0 in the first cell and {S=0, L=14, Mapping type B, k0=2} for the PDSCH #1 in the second cell.

In another embodiment, for multi-cell scheduling, a row of the TDRA table can indicate PDSCHs or PUSCHs that are in different cells, by configuring a row index from the TDRA table of the scheduled cell and BWP for each PDSCH or PUSCH in the row of TDRA table. This option can help reduce the signaling overhead for the TDRA configuration for multi-cell scheduling.

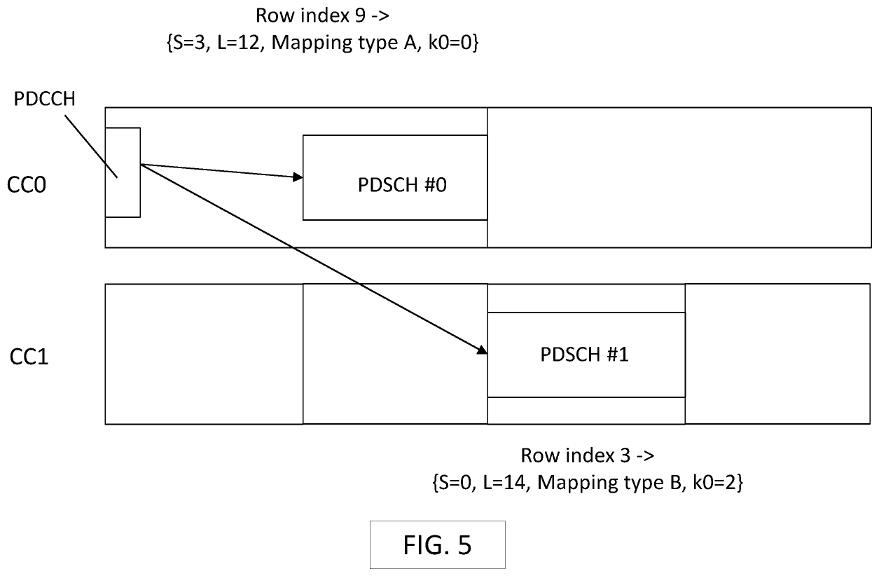

FIG. 5 illustrates a TDRA indication for multi-cell scheduling in accordance with some embodiments. In FIG. 5, the number of rows for TDRA table #0 for the first cell is 16 and number of rows for TDRA table #1 for the second cell is 8. Further, the SCS for CC #0 and CC #1 is 15 kHz and 30 kHz, respectively. For a DCI that is used to schedule PDSCHs in two cells, the indicated row includes the {row index=9} of the TDRA table #0 for the first cell and {row index=3} of the TDRA table #1 for the second cell. Based on the indication, the UE can determine the time domain resource allocation for the scheduled PDSCHs in the first and second cell.

In another embodiment, for multi-cell scheduling, a cell index and/or BWP index can be included in as part of TDRA table. In this case, a carrier indicator or BWP indicator may not be included in the DCI for multi-cell scheduling.

In one option, a row of the TDRA table can indicate PDSCHs or PUSCHs that are in different cells, by configuring {cell or carrier index, SLIV, mapping type, scheduling offset K0 or K2} for each PDSCH or PUSCH in a cell in the row of TDRA table.

In another option, a row of the TDRA table can indicate PDSCHs or PUSCHs that are in different cells, by configuring {cell or carrier index, BWP index, SLIV, mapping type, scheduling offset K0 or K2} for each PDSCH or PUSCH in a cell in the row of TDRA table.

In another option, a row of the TDRA table can indicate PDSCHs or PUSCHs that are in different cells, by configuring {cell or carrier index, a row index from the TDRA table of the corresponding cell} for each PDSCH or PUSCH in the row of TDRA table.

In another option, a row of the TDRA table can indicate PDSCHs or PUSCHs that are in different cells, by configuring {cell or carrier index, BWP index, a row index from the TDRA table of the corresponding cell} for each PDSCH or PUSCH in the row of TDRA table.

In another embodiment, for multi-cell scheduling, a single TDRA field is commonly applied for the all the scheduled cells indicated in the DCI or the cells in a cell group. In addition, a same time domain resource allocation is applied for PDSCH or PUSCH in the determined cells. In this case, a separate TDRA table can be configured for the scheduling cell for multi-cell scheduling, which can be independent from the TDTA table for the single-cell scheduling.

In another embodiment, for multi-cell scheduling, a row of the TDRA table can indicate time domain resource allocation of PDSCHs or PUSCHs that are in different cells, by configuring {SLIV, mapping type, scheduling offset K0 or K2} for all the configured cells.

In this case, assuming the number of cells that are configured for multi-cell scheduling is K, each row of the TDRA table include K set of parameters {SLIV, mapping type, scheduling offset K0 or K2} for multi-cell scheduling. After the UE determines the cell index for the PDSCH or PUSCH transmission, the UE determines the time domain resource allocation from the indicated row of the TDRA table in accordance with the determined cell index.

In one example, assuming 3 cells are configured for multi-cell scheduling, one row of the TDRA table includes {SLIV, mapping type, scheduling offset K0 or K2} for cell #0, {SLIV, mapping type, scheduling offset K0 or K2} for cell #1, {SLIV, mapping type, scheduling offset K0 or K2} for cell #2. In this case, the UE first determines the cell index as cell #0, and cell #2 for multi-cell scheduling from the cell indication. Subsequently, the UE determines the time domain resource allocation for {SLIV, mapping type, scheduling offset K0 or K2} for cell #0 and {SLIV, mapping type, scheduling offset K0 or K2} for cell #2.

In another embodiment, for multi-cell scheduling, the number of repetitions for the transmission of PDSCHs or PUSCHs in each scheduled cell or configured cell can be included as the set of parameters in a row of the TDRA table, i.e., {SLIV, mapping type, scheduling offset K0 or K2, number of repetitions}.

In another option, a number of repetitions can be commonly applied for the transmission of PDSCHs or PUSCHs in each cell for multi-cell scheduling. In this case, the number of repetitions can be separately included in a row of the TDRA table from {SLIV, mapping type, scheduling offset K0 or K2}.

In another embodiment, for multi-cell scheduling, a row of the TDRA table can indicate time domain resource allocation of PDSCHs or PUSCHs that are in different cells, by configuring a row index from the TDRA table for each PDSCH or PUSCH for all the configured cells.

For this option, after the UE determines the cell index and BWP index for the PDSCH or PUSCH transmission, the UE determines the time domain resource allocation from the indicated row of the TDRA table in accordance with the determined cell index and BWP index.

In one example, assuming 3 cells are configured for multi-cell scheduling, one row of the TDRA table includes {row index #4} for cell #0/BWP #0, {row index #3} for cell #1/BWP #2, {row index #8} for cell #2/BWP #1. In this case, the UE first determines the cell/BWP index as cell #0/BWP #0, and cell #2/BWP #1 for multi-cell scheduling from the cell and BWP indication. Subsequently, the UE determines the time domain resource allocation based on the row index #4 of the configured TDRA table for cell #0 and BWP #0, and the row index #8 of the configured TDRA table for cell #2 and BWP #1.

In another embodiment, for multi-cell scheduling, a row of the TDRA table can indicate time domain resource allocation of PDSCHs or PUSCHs that are in different cells, by configuring a row index from a TDRA table of the scheduled cell for each PDSCH or PUSCH for all the configured cells. The TDRA table for each PDSCH or PUSCH is determined by the BWP index of the scheduled cell, which can be indicated by the BWP indicator field and carrier indicator field or the joint carrier/BWP indictor field.

For this option, after the UE determines the cell index and BWP index for the PDSCH or PUSCH transmission, the UE determines the time domain resource allocation from the indicated row of the TDRA table in accordance with the determined cell index and BWP index.

In one example, assuming 3 cells are configured for multi-cell scheduling. gNB configures TDRA table for each cell and each BWP respectively, and gNB additionally configures a TDRA table for multi-cell scheduling with row indexes for all configured cell in a row. Assuming one row of the TDRA table includes {row index #4} for cell #0, {row index #3} for cell #1, {row index #8} for cell #2.

In this case, the UE first determines the cell/BWP index as cell #0/BWP #0, and cell #2/BWP #1 for multi-cell scheduling from the cell and BWP indication. Subsequently, the UE determines the time domain resource allocation based on the row index #4 of the configured TDRA table for cell #0 with BWP #0, and the row index #8 of the configured TDRA table for cell #2 with BWP #1, respectively. Finally, the UE determines that the time domain resource allocation for cell #0 and BWP #0, and that for cell #2 and BWP #1.

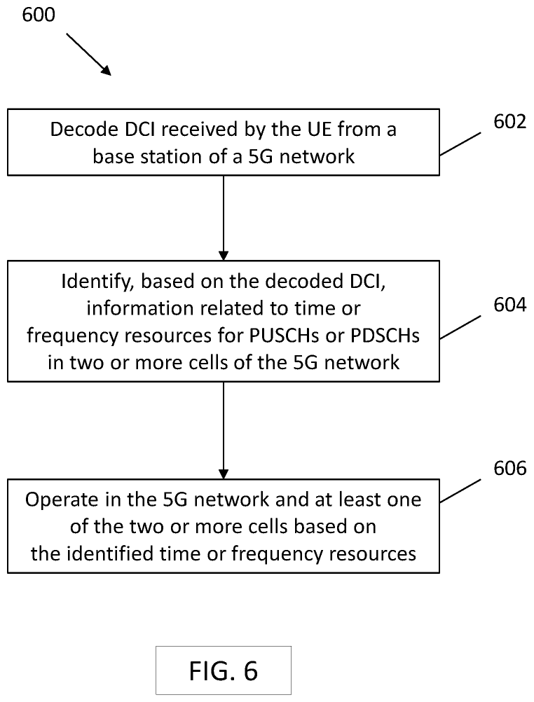

FIG. 6 illustrates a flowchart of DCI reception in accordance with some embodiments. Additional operations may be present in the method 600 of FIG. 6, but are not shown for convenience. The method 600 may be performed by a UE in a 5G cellular network. The method 600 may include decoding, at operation 602, a DCI received by the UE from a base station of the 5G network; identifying, at operation 604 based on the decoded DCI, information related to time or frequency resources for PUSCHs or PDSCHs in two or more cells of the 5G network; and operating, at operation 606, in the 5G network and at least one of the two or more cells based on the identified time or frequency resources.

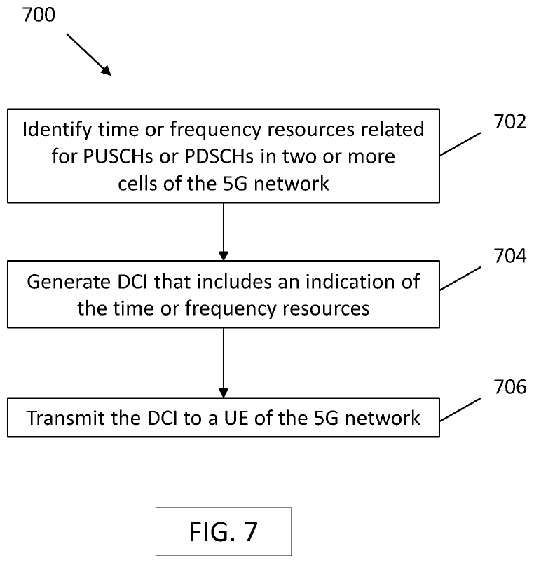

FIG. 7 illustrates a flowchart of DCI reception in accordance with some embodiments. Additional operations may be present in the method 700 of FIG. 7, but are not shown for convenience. The method 700 may be performed by a base station in a 5G cellular network. The method 700 may include identifying, at operation 702, time or frequency resources related for PUSCHs or PDSCHs in two or more cells of the 5G network; generating, at operation 704, a DCI that includes an indication of the time or frequency resources; and transmitting, at operation 706, the DCI to a UE of the 5G network.

### EXAMPLES

Example 1 is an apparatus for a next generation radio access network (NG-RAN) node, the apparatus comprising: memory; and processing circuitry, to configure the NG-RAN node to: determine whether at least one of physical uplink shared channels (PUSCHs) or physical downlink shared channels (PDSCHs) for a plurality of cells is to be scheduled for a user equipment (UE) in multi-cell scheduling; and in response to a determination that at least one of PUSCHs or PDSCHs for plurality of cells is to be scheduled for the UE, send to the UE downlink control information (DCI) configured to schedule the at least one of the PUSCHs or PDSCHs in the plurality of cells; and wherein the memory is configured to store the DCI.

In Example 2, the subject matter of Example 1 includes, wherein for the multi-cell scheduling, the processing circuitry is configured to indicate each cell among the plurality of cells for which the at least one of PUSCHs or PDSCHs is to be scheduled for the UE via a carrier indication bitmap in the DCI.

In Example 3, the subject matter of Examples 1-2 includes, wherein the processing circuitry is configured to configure, to the UE, a carrier indication table to indicate a set of carriers that are scheduled by the DCI by at least one of: higher layers via at least one of a new radio (NR) remaining minimum system information (RMSI), NR other system information (OSI), or dedicated radio resource control (RRC) signaling, or dynamically in the DCI.

In Example 4, the subject matter of Examples 1-3 includes, wherein the processing circuitry is configured to indicate a set of carriers via a carrier indication bitmap.

In Example 5, the subject matter of Examples 1-4 includes, wherein the processing circuitry is configured to indicate, using a single field in the DCI, whether the DCI is for single cell scheduling or the multi-cell scheduling.

In Example 6, the subject matter of Examples 1-5 includes, wherein for the multi-cell scheduling, the processing circuitry is configured to indicate a bandwidth part (BWP) index for the scheduled cells or configured cells for the multi-cell scheduling.

In Example 7, the subject matter of Examples 1-6 includes, wherein for the multi-cell scheduling, the processing circuitry is configured to: configure a bandwidth part (BWP) table by dedicated radio resource control (RRC) signaling, and indicate, via a single BWP indication field in the DCI, a BWP index for each of the scheduled cells according to the BWP table.

In Example 8, the subject matter of Examples 1-7 includes, wherein for the multi-cell scheduling, the processing circuitry is configured to indicate, via a single bandwidth part (BWP) indication field, a BWP index for the scheduled cells or cells in a cell group.

In Example 9, the subject matter of Examples 1-8 includes, wherein for the multi-cell scheduling, the processing circuitry is configured to configure, by dedicated radio resource control (RRC) signaling, a joint carrier and a bandwidth part (BWP) indication table, one field in the DCI being used to select one row of the carrier and BWP indication table for both a carrier and BWP indication.

In Example 10, the subject matter of Examples 1-9 includes, wherein for the multi-cell scheduling, an uplink/supplementary uplink (UL/SUL) indicator is not present regardless of whether the UE is configured with supplementaryUplink in ServingCellConfig in each cell.

In Example 11, the subject matter of Examples 1-10 includes, wherein for the multi-cell scheduling, the processing circuitry is configured to configure the UE with a same resource allocation (RA) type for a resource allocation in frequency domain for all scheduled cells or cells in a same cell group.

In Example 12, the subject matter of Examples 1-11 includes, wherein for the multi-cell scheduling, a common frequency domain resource allocation (FDRA) field is applied for all scheduled cells or cells in a cell group, a FDRA field size is determined in accordance with a bandwidth of a reference bandwidth part (BWP) in one of the scheduled cells.

In Example 13, the subject matter of Example 12 includes, wherein the processing circuitry is configured to: determine that a size of common FDRA field is greater than a determined FDRA field size for an active or indicated BWP of the one of the scheduled cells, and apply truncation to the common FDRA field size to match with the determined FDRA field size for an active or indicated BWP of the one of the scheduled cells.

In Example 14, the subject matter of Examples 12-13 includes, wherein the processing circuitry is configured to: configure a resource allocation (RA) type for the at least one of the PDSCH or PUSCH as one of RA type 0 or RA type 1, determine that a bandwidth of an active or indicated BWP is different from the bandwidth of the reference BWP of the one of the scheduled cells, and in response to a determination that the bandwidth of the active or indicated BWP is different from the bandwidth of the reference BWP of the one of the scheduled cells, determine and apply a scaling factor to the FDRA of the active or indicated BWP for the at least one of the PDSCH or PUSCH.

In Example 15, the subject matter of Examples 1-14 includes, wherein for the multi-cell scheduling, at least one of: the processing circuitry is configured to include time domain resource allocation (TDRA) field in the DCI and for application to at least one of PDSCHs or PUSCHs in N_Cell cells scheduled by the DCI, the processing circuitry is configured to indicate PDSCHs or PUSCHs that are in different cells via a row of a time domain resource allocation (TDRA) table through configuration of at least one of: {a starting and length indicator value (SLIV), mapping type, scheduling offset K0 or K2} for each PDSCH or PUSCH in each scheduled cell in the row of the TDRA table, or a row index from the TDRA table of the scheduled cell for each PDSCH or PUSCH in the row of TDRA table, a single TDRA field is commonly applied for all of the scheduled cells indicated in the DCI or cells in a cell group.

In Example 16, the subject matter of Examples 1-15 includes, wherein each row of the TDRA further comprises a number of repetitions for transmission of PDSCHs or PUSCHs in each scheduled cell or configured cell.

Example 17 is an apparatus for a user equipment (UE), the apparatus comprising: memory; and processing circuitry, to configure the UE to: receive, from a next generation radio access network (NG-RAN) node, downlink control information (DCI) configured to schedule at least one of physical uplink shared channels (PUSCHs) or physical downlink shared channels (PDSCHs) for a plurality of cells; and send the PUSCH for the plurality of cells in response to a determination that the DCI schedules PUSCHs for the plurality of cells, and receive the PDSCHs from the plurality of cells in response to a determination that the DCI schedules PDSCHs for the plurality of cells; and wherein the memory is configured to store the DCI.

In Example 18, the subject matter of Example 17 includes, wherein each cell among the plurality of cells for which the at least one of PUSCHs or PDSCHs are scheduled for the UE is indicated via a carrier indication bitmap in the DCI.

Example 19 is a non-transitory computer-readable storage medium that stores instructions for execution by one or more processors of a next generation radio access network (NG-RAN) node, the one or more processors to configure the NG-RAN node to, when the instructions are executed: determine whether at least one of physical uplink shared channels (PUSCHs) or physical downlink shared channels (PDSCHs) for a plurality of cells is to be scheduled for a user equipment (UE) in multi-cell scheduling; and in response to a determination that at least one of PUSCHs or PDSCHs for plurality of cells is to be scheduled for the UE, send to the UE downlink control information (DCI) configured to schedule the at least one of the PUSCHs or PDSCHs in the plurality of cells.

In Example 20, the subject matter of Example 19 includes, wherein the instructions, when executed, further configure the one or more processors to indicate each cell among the plurality of cells for which the at least one of PUSCHs or PDSCHs is to be scheduled for the UE via a carrier indication bitmap in the DCI.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1-40. (canceled)

41. A user equipment (UE) configured for operation in a fifth-generation new radio (5G NR) network, the UE comprising: processing circuitry; and memory, wherein the processing circuitry is configured to:
decode a multi-cell downlink control information (MC-DCI) received from a generation Node B (gNB), the MC-DCI scheduling multiple physical downlink shared channels (PDSCHs) in multiple cells; and
decode the multiple PDSCHs received in the multiple cells in accordance with the MC-DCI, wherein one of the multiple PDSCHs is scheduled to be received per cell,
wherein the MC-DCI includes:
a scheduled cells indicator indicating scheduled cells,
a bandwidth part (BWP) indicator for the scheduled cells, and
a time domain resource assignment (TDRA) field for the scheduled cells.

42. The UE of claim 41, wherein the scheduled cells indicator comprises a bitmap that indicates the scheduled cells.

43. The UE of claim 42, wherein the BWP indicator indicates a maximum number of downlink BWPs configured across the scheduled cells.

44. The UE of claim 43, wherein the TDRA field indicates a TDRA for each BWP of each of the scheduled cells.

45. The UE of claim 44, wherein for each of the scheduled cells,
the processing circuitry is configured to decode one of the multiple PDSCHs in each scheduled cell in accordance with the TDRA for each BWP for each scheduled cell.

46. The UE of claim 45, wherein the MC-DCI further includes a scheduling offset indicator field for use in determining a scheduling offset for the downlink BWPs configured across the scheduled cells.

47. The UE of claim 46, wherein the MC-DCI further includes a supplementary uplink (SUL) indicator for the scheduled cells.

48. The UE of claim 46, wherein prior to receipt of the MC-DCI, the processing circuitry is configured to decode radio resource control (RRC) information to configure the scheduled cells to be indicated by the MC-DCI.

49. The UE of claim 42, wherein the processing circuitry is further configured to:
decode a second MC-DCI received from the gNB, the second MC-DCI scheduling multiple physical uplink shard channels (PUSCHs) in multiple cells; and
encode the multiple PUSCHs for transmission in multiple cells in accordance with the second MC-DCI, wherein one of the multiple PUSCHs is to be transmitted per cell.

50. The UE of claim 49, wherein the second MC-DCI includes wherein the MC-DCI includes:
a scheduled cells indicator indicating scheduled cells,
a bandwidth part (BWP) indicator for the scheduled cells, and
a time domain resource assignment (TDRA) field for the scheduled cells.

51. A non-transitory computer-readable storage medium that stores instructions for execution by processing circuitry of a user equipment (UE) configured for operation in a fifth-generation new radio (5G NR) network, the processing circuitry is configured to:
decode a multi-cell downlink control information (MC-DCI) received from a generation Node B (gNB), the MC-DCI scheduling multiple physical downlink shared channels (PDSCHs) in multiple cells; and
decode the multiple PDSCHs received in the multiple cells in accordance with the MC-DCI, wherein one of the multiple PDSCHs is scheduled to be received per cell,
wherein the MC-DCI includes:
a scheduled cells indicator indicating scheduled cells,
a bandwidth part (BWP) indicator for the scheduled cells, and
a time domain resource assignment (TDRA) field for the scheduled cells.

52. The non-transitory computer-readable storage medium of claim 51, wherein the scheduled cells indicator comprises a bitmap that indicates the scheduled cells.

53. The non-transitory computer-readable storage medium of claim 52, wherein the BWP indicator indicates a maximum number of downlink BWPs configured across the scheduled cells.

54. The non-transitory computer-readable storage medium of claim 53, wherein the TDRA field indicates a TDRA for each BWP of each of the scheduled cells.

55. The non-transitory computer-readable storage medium of claim 54, wherein for each of the scheduled cells,
the processing circuitry is configured to decode one of the multiple PDSCHs in each scheduled cell in accordance with the TDRA for each BWP for each scheduled cell.

56. The non-transitory computer-readable storage medium of claim 55, wherein the MC-DCI further includes a scheduling offset indicator field for use in determining a scheduling offset for the downlink BWPs configured across the scheduled cells.

57. The non-transitory computer-readable storage medium of claim 56, wherein the MC-DCI further includes a supplementary uplink (SUL) indicator for the scheduled cells.

58. The non-transitory computer-readable storage medium of claim 56, wherein prior to receipt of the MC-DCI, the processing circuitry is configured to decode radio resource control (RRC) information to configure the scheduled cells to be indicated by the MC-DCI.

59. An apparatus of a generate Node B (gNB) configured for operation in a fifth-generation new radio (5G NR) network, the gNB comprising: processing circuitry; and memory, wherein the processing circuitry is configured to:
encode a multi-cell downlink control information (MC-DCI) received from a generation Node B (gNB), the MC-DCI scheduling multiple physical downlink shared channels (PDSCHs) in multiple cells; and
encode the multiple PDSCHs for transmission in the multiple cells in accordance with the MC-DCI, wherein one of the multiple PDSCHs is scheduled to be transmitted per cell,
wherein the MC-DCI includes:
a scheduled cells indicator indicating scheduled cells,
a bandwidth part (BWP) indicator for the scheduled cells, and
a time domain resource assignment (TDRA) field for the scheduled cells.

60. The apparatus of claim 59, wherein the scheduled cells indicator comprises a bitmap that indicates the scheduled cells,
wherein the BWP indicator indicates a maximum number of downlink BWPs configured across the scheduled cells, and
wherein the TDRA field indicates a TDRA for each BWP of each of the scheduled cells.
